(19) United States
(12) Patent Application Publication
(10) Pub. No.: US 2007/0066732 A1
(43) Pub. Date: Mar. 22, 2007

(54) Skid resistant coating

(76) Inventors: Robert F. Stahovic, Cambridge Spings, PA (US); Judith A. Stahovic, Cambridge Springs, PA (US)

Correspondence Address: THE BECK LAW FIRM;Suite 900, 1429 Walnut Street, Philadelphia, PA, 19102, US

(21) Appl. No.: 11/229,739

(22) Filed: Sep. 19, 2005

(51) Int. Cl. C08K 5/06

(52) U.S. Cl. 524/376

(57) ABSTRACT

A water based coating which is smooth and skid resistant when dry and which has increased skid resistance when wet. The coating comprises water, a polymer dispersion, a coalescing agent, and an anti-slip material. The coating also includes a mar resistant material, an ultraviolet light absorber, and a light stabilizer. Further, the coating also includes a fungicide and a biocide. A method of making a water based coating that is smooth and skid resistant when dry and which has increased resistance when wet. It comprises the steps of forming a pre-mix, adding water to said premix, and then adding an anti-skid agent. The, pre-mix comprises a polymer dispersion, a coalescing agent, a surfactant, and a defoaming agent. It further includes the steps stirring said pre-mix and said water at room temperature until said mixture is homogeneous, adding a mar resistant material, an ultra violet light absorber, a light stabilizer, a fungicide, and a biocide.

### FIELD OF THE INVENTION

This invention relates to protective and more particularly, to a coating which is smooth and skid resistant when dry and which has increased skid resistance when wet.

### BACKGROUND OF THE INVENTION

A problem which arises with many surfaces and in particular surfaces on which people may walk or run is that their surfaces, which are normally resistant to sliding or slipping when they are dry, become hazardous when they become wet such as during rain, as in the case with outdoor tiles and decks. The problem is not limited to outdoor environments since indoor surfaces suffer the same disability, such as when liquid is spilled or used for cleaning. Thus the surfaces become slick and highly dangerous in that people walking on the wet surfaces may slip and seriously injure themselves.

With the foregoing in mind, it would be desirable to create a water based coating that is smooth and skid resistant when dry and which has increased skid resistence when wet. Preferably such a coating would be applied to the surface to be treated as a fluid by brush, roller, squeegee or by being sprayed, all as well known in the art of applying fluid coatings to surfaces.

### SUMMARY OF THE INVENTION

With the foregoing in mind, the invention relates generally to a coating comprising water, a polymer dispersion, a coalescing agent, an evaporation rate controlling agent, and an anti-slip agent.

In another aspect the invention relates to a coating comprising water, a polymer dispersion, a coalescing agent, an evaporation rate controlling agent, an anti-slip agent, means for controlling organisms, and means providing light protection.

### DETAILED DESCRIPTION OF THE INVENTION

The coating is preferably water-based and includes a polymer dispersion, a coalescing agent, and evaporation rate controlling agent and an anti-slip agent.

To aid in its application to the surface to be coated, the coating also includes a surfactant, a low foam wetting agent, an anti-foaming agent, and an agent for controlling the rate of evaporation to thereby control the speed at which the coating dries.

Further, to enhance the durability and life of the coating it preferably includes materials for reducing its deterioration as a result of being exposed to light and organisms.

The coating is applied to the surface to be protected as a fluid. The application can be by brush, roller, squeegee or by being sprayed.

In the case of ceramics such as tiles or other factory manufactured items the coating can be applied by being sprayed on the item at the manufacturing site as one of the last steps in the manufacturing process.

However, with respect to decks, flooring and the like the coating can be more easily applied on site by brush, roller, squeegee, or by being sprayed after the structure is assembled.

It is preferred that the water comprise about 10-80% of the total weight of the polymer dispersion. However, in some applications, such as waterproofing bisque vases or other ceramics the water can comprise 60-80% of the total weight of the polymer dispersion.

Preferably, the polymer dispersion may be an acrylic-urethane hybrid polymer, such as HYBRIDUR which is available from Air Products Corporation. HYBRIDUR is characterized as comprising about 40% solids; viscosity of about 50-250 cP; a pH of about 7.5-8.8; a colloidal particle size; anionic particle charge; and a VOC of about 1.35 lb/gal.

The HYBRIDUR is the preferred acrylic-urethane hybrid polymer because it seems to provide the best hardness and flexibility to the coating. Flexibility without cracking the coating after it is applied to woods, tiles, metals, glass plastics, rubber, cloth and other similar substrate because of their tendency to flex under loads such as are created by people walking across them.

Further, the characteristics of the polymer dispersion can be modified by varying the quantity of water.

The coalescing agent is operative to cause the dispersion to coalesce into the coating as it evaporates after it is applied to the surface.

A coalescing agent such as dipropylene glycol normal butyl ether (DBNP) which is sold under the name ARCOSOLV DPNB by Lyondell Chemical Company of Houston, Tex.

The coalescing agent should be about 3.75 to 10.5 percent of the total weight of the polymer dispersion.

The evaporation rate controlling agent for controlling the rate at which the coating dries can be tripropylene glycol (mono) methyl ether. This composition is colorless and is completely soluble in water and has low volatility and evaporates slowly.

A suitable composition of tripropylene glycol (mono) methyl ether for controlling the evaporation rate of the coating is ARCOSOLV TPM which is available from Lyondell Chemical Company of Houston, Tex.

The evaporation agent should be about 3.75 to 10.5 percent of the total weight of the polymer dispersion.

Controlling the rate of evaporation is assisted by varying the amounts of DPNB and TPM.

By varying the amount of polymer dispersion, coalescing agent, and evaporation agent in the coating, the rate of drying and curing process can be maximized.

Additionally, a suitable surfactant is advantageously employed to enable the coating to be spread more easily by lowering the surface tension.

The surfactant should have low volatility and low foaming characteristics. One of the preferred surfactants is an ultra low VOC, low foam, nonionic wetting agent such as DYNOL 604 manufactured by Air Products and Chemicals of Allentown, Pa. which is an Acetylenic-based.

The surfactant should be about 0.5 to 1.55 percent of the total weight of the polymer dispersion.

Further, a second surfactant such as a polyether modified poly-dimethyl-siloxane which is low foaming and which improves flow and leveling is used advantageously. A suitable second surfactant is BYK No. 346 which is available from BYK-Chemie USA, Inc. of Wallingford, Conn.

The BYK No. 346 surfactant should be about 0.83 to 1.65 percent of the total weight of the polymer dispersion.

The BYK 346 is used advantageously in combination with the DYNOL No. 604.

However, if desired the concentration of the surfactants in the coating could be increased by up to 25% of the concentrations mentioned above without disadvantageously affecting the properties of the coating.

Foaming is further suppressed by using a defoamer which may comprise a mixture of hydrophobic solids and foam destroying polysiloxanes such as are available from BYK-Chemie as BYK-022.

Typically, the defoamer comprises 0.13% to 0.18% of the total weight of the polymer dispersion.

A preferred anti-slip material comprises an anionic polybutene wax emulsion, such as MICHEM emulsion No. 35160, which is available from Michelman, Inc. of Cincinnati, Ohio The quantity of the polybutene wax emulation should be between about 1-30% of total weight of the coating.

The MICHEM 35160 is especially advantageous since in addition to providing skid resistance, it also provides some mar resistance to the extent that there is increased resistance to marring materials such scratches, scuff marks and the like on the surface of the coating.

Nonetheless, another preferred mar resistant material is TROYSOL MS-2 which should be applied at about 0.4% to about 0.9% of the total weight of the coating. The TROYSOL MS-2 is especially useful in protecting the surface of the coating due to its improved mar resistance. However, since it does exhibit increased surface slip, it is still necessary to use the MICHEM 35160 because of its anti-skid characteristics.

Additional constituents are provided to increase the life and durability of the coating. They include materials which increase the stability of the coating when it is used out of doors and make it resistant to attack by organisms.

Both an ultraviolet light absorber and a light stabilizer are provided.

Preferably, the ultra violet light absorber comprises TINUVIN No. 1130. The TINUVIN No. 1130 is a liquid ultra violet absorber of the hydroxyphenylbenzotriazole class specifically developed for coatings. It is comprised of two active ingredients; namely, S-[3-(2-H-Benzotriazole-2-yl)-4-hydroxy-5-tert.butylphenyl]-propionic acid-poly(ethylene glycol) 300-ester and Bis{β-[3-(2-H-Benzotriazole-2-yl)-4-hydroxy-5-tert.butylphenyl]-propionic acid}-poly(ethylene glycol) 300-ester. (CAS No, 104810-48-2).

The preferred light stabilizer is TINUVIN No. 292 which is a hindered amine light stabilizer especially developed for coatings. It is comprised of two active ingredients; namely, Bis(1,2,2,6,6-pentamethyl-4-piperidyl) sebacate (CAS No. 4156-26-7); and Methyl 1,2,2,6,6-pentamethyl-4-piperidyl) sebacate (CAS No. 82919-37-7).

The TINUVIN No. 292 is used advantageously to keep the coating liquid and provide significantly extended life to the coating minimizing defects such as cracking and loss of gloss when used in conjunction with the TINUVIN No. 1130.

The ultra violet light absorber should typically be between about 0.55 and 3.0 percent of the total weight of the polymer dispersion.

The light stabilizer should be about 0.55 to 2.0 percent of the total weight of the polymer dispersion.

Both TINUVIN No. 1130 and TINUVIN No. 292 are available from Ciba Specialty Chemical Corporation of Tarrytown, N.Y.

A fungicide, and biocide are used advantageously to help the coating to resist attacks by organisms both before and after it is applied to the desired surface.

The fungicide and biocide as a group should typically be between about 0.91 and 2.0 percent of the total weight of the water. However, the amounts of the various “cides” relative to each other, and as a part of the coating can be varied to meet local conditions.

A suitable fungicide is TROYSAN POLYPHASE P-20T which has as its active ingredients 3-iodo2-propynyl butyl carbabate. It is especially useful in the coating because it is compatible with water and solvent based system and is non-metallic and non-corrosive. It is a broad spectrum fungicide which is effective in inhibiting the growth of a wide range of fungi, algae and yeasts.

TROYSAN POLYPHASE P-20T is available from the TROY Chemical company of East Hanover, N.J.

The fungicide should be about 0.3 to 1.0 percent of the total weight of the water with the variations as explained above.

A suitable biocide is an aminoethanol compound such as that sold under the name TROYSAN 174 by the Troy Chemical Company of East Hanover, N.J. TROYSAN 174 is especially advantageous since in addition to being a biocide it also serves as an in-can preservative for the coating while it is being stored or shipped.

The biocide should be about 0.61 to 1.0 percent of the of the total weight of the water with the variations as explained above.

The coating is manufactured by creating two pre-mixes, combining them and then adding the biocide.

The first pre-mix comprises the acrylic urethane polymer dispersion to which is added the water and the fungicide. Adding the water and fungicide to the acrylic urethane polymer dispersion instead of adding the dispersion to the water and fungicide avoids the creation of clumps of material which would make the final mixture unusable.

The second pre-mix which comprises the coalescing agent, the evaporation rate controlling agent, the surfactants, defoamer, the anti-skid/mar resistant composition, the UV light absorber, and light stabilizer is then added to the first pre-mix.

Preferably, the coalescing agent and evaporation controlling agent, i.e., dipropylene glycol normal butyl ether (DBNP) and tripropylene glycol (mono) methyl ether (TPM) are present in generally equal parts

The first and second pre-mixes can be stirred or otherwise mixed at room temperature until the mixture is homogeneous.

The biocide is added to the combination of the first and second pre-mixes.

It is important that the biocide be added last. This is because if it is mixed with the fungicide they may neutralize each other so that neither the fungicide or the biocide is effective.

A typical coating made in accordance with the invention will consist of the following weights (in any units) of constituents as is consistent with the proportions mentioned earlier:

| Ingredient | Brand | Weight |
|---|---|---|
| Water | | 755.7 |
| Polymer dispersion | HYBRIDUR | 2,519.1 |
| coalescing agent | DPNB | 188.9 |
| low VOC solvent | TPM | 188.9 |
| Surfactant | 346 | 20.9 |
| Defoamer | 022 | 6.2 |
| Low foam surfactant | 604 | 27.7 |
| Anti-skid/Mar resist | 35160 | 1-30% of total weight |
| UV absorber | 1130 | 37.7 |
| Light stabilizer | 292 | 18.8 |
| Fungicide (broad spectrum) | P-20T | 15.3 |
| Biocide | 174 | 7.5 |

The coating can be packaged for sale in airtight containers such as drums, cans or bottles to prevent the evaporating agent from drying the coating before it is applied.

It is applied to the surface which is to be coated by brush, roller, squeegee or by being sprayed. Typically, it takes about 2 or 3 days for the coating to cure and harden.

It has been found that the coating is impervious to water. Even though it becomes wet, such as with spilled liquids or rain, people can walk on it without fear of sliding. Further, because of its mar-resistant qualities, it remains bright and attractive.

While the invention has been described with a particular preferred embodiment, it is apparent that other forms of embodiments would be obvious to those skilled in the art in view of the foregoing description.

1. A water based coating that is smooth and skid resistant when dry and which has increased skid resistance when wet comprising
water,
a polymer dispersion,
a coalesing agent, and an
anti-slip material.

2. A water based coating as defined in claim 1 wherein
said polymer dispersion is a urethane hybrid polymer,
said coalesing agent comprises dipropylene glycol normal butyl ether, and
said anti-slip material comprises an anionic polybutene wax emulsion.

3. A water based coating as defined in claim 2 wherein
the amount of said water, by weight, is between 10.0% and 80.0% of the total weight of said polymer dispersion,
the amount of said coalescing agent, by weight, is between 3.75% and 10.0% of the total weight of said polymer dispersion, and
the amount of said anti-slip material is between 1.0% and 30.0% of the total weight of said polymer dispersion.

4. A water based coating as defined in claim 1 including
an evaporating agent,
a surfactant, and
defoaming agent.

5. A water based coating as defined in claim 4 wherein
said evaporating agent is tripropylene glycol (mono) methyl ether,
said surfactant comprises a first surfactant which is an ultra low VOC, low foam non-ionic wetting agent, and a second surfactant which is a low foaming polyether modified poly-dimethyl siloxane, and
said defoaming agent includes a mixture of hydrophobic solids and foam destroying polysiloxanes.

6. A water based coating as defined in claim 5 wherein
the amount of said evaporating agent, by weight, is between 3.75% and 10.5% of the total weight of said polymer dispersion,
the amount of said first surfactant, by weight, is between 0.5% and 1.55% of the total weight of said polymer dispersion, and
the amount of said second surfactant, by weight, is between 0.835 and 1.65% of the total weight of said polymer dispersion, and
the amount of said defoaming agent is between 0.13% and 0.18% of the total weight of said polymer dispersion.

7. A water based coating as defined in claim 1 including
a mar resistant material.

8. A water based coating as defined in claim 7 wherein
the amount of said mar resistant material is between 0.4% and 0.9% of the total weight of said polymer dispersion.

9. A water based coating as defined in claim 1 including
an ultraviolet light absorber, and a light stabilizer.

10. A water based coating as defined in claim 9 wherein
wherein said ultraviolet light absorber is of the hydroxyphenylbenzotriazole class.

11. A water based coating as defined in claim 10 wherein
wherein the amount of said ultraviolet light absorber, by weight, is between about 0.55% and 3.00% of the total weight of the polymer dispersion.

12. A water based coating as defined in claim 9 wherein
said light stabilizer is a hindered amine light stabilizer.

13. A water based coating as defined in claim 12 wherein
wherein the amount of said light stabilizer, by weight, is between about 0.55% and 2.00% of the total weight of the polymer dispersion.

14. A water based coating as defined in claim 1 including
a fungicide.

15. A water based coating as defined in claim 14 wherein
said fungicide includes 3-iodo2-propynyl butyl carabate.

16. A water based coating as defined in claim 15 wherein
wherein the amount of said fungicide, by weight, is between about 0.3% and 1.0% of the total weight of the water.

17. A water based coating as defined in claim 1 including
a biocide.

18. A water based coating as defined in claim 17 wherein
said biocide includes an aminoethanol compound.

19. A water based coating as defined in claim 18 wherein
wherein the amount of said biocide, by weight, is between about 0.61% and 1.0% of the total weight of said water.

20. The method of making a water based coating that is smooth and non-skid when dry and skid resistant when wet comprising the steps of
forming a pre-mix comprising a polymer dispersion and water,
forming a second pre-mix comprising a coalescing agent, an evaporation rate controlling agent, a surfactant, an antifoaming agent and an anti-skid agent, and
combining said first and second pre-mixes.

21. The method as defined in claim 20 wherein
said polymer dispersion is a urethane hybrid polymer,
said coalescing agent comprises dipropylene glycol normal butyl ether,
said surfactant comprises a first surfactant which is an ultra low VOC, low foam non-ionic wetting agent, and a second surfactant which is a low foaming polyether modified poly-dimethyl siloxane, and
said defoaming agent includes a mixture of hydrophobic solids and foam destroying polysiloxanes.

22. The method as defined in claim 21 including the step of
stirring said pre-mix and said water at room temperature until said mixture is homogeneous.

23. The method as defined in claim 20 wherein
said anti-slip material comprises an anionic polybutene wax emulsion.

24. The method as defined in claim 22 wherein
the amount of said water, by weight, is between 10.0% and 80.0% of the total weight of said polymer dispersion,
the amount of said coalescing agent, by weight, is between 3.75% and 10.0% of the total weight of said polymer dispersion, and
the amount of said first surfactant, by weight, is between 0.5% and 1.55% of the total weight of said polymer dispersion, and
the amount of said second surfactant, by weight, is between 0.835 and 1.65% of the total weight of said polymer dispersion, and
the amount of said defoaming agent is between 0.13% and 0.18% of the total weight of said polymer dispersion, and
the amount of said anti-slip material is between 1.0% and 30.0% of the total weight of said polymer dispersion.

25. The method as defined in claim 20 including the step of adding a mar resistant material to said mixture.

26. The method as defined in claim 25 wherein
the amount of mar resistant material is between 0.4% and 0.9% of the total weight of said polymer dispersion.

27. The method as defined in claim 20 including the step of adding an ultra violet light absorber.

28. The method as defined in claim 27 wherein
said ultraviolet light absorber is of the hydroxyphenylbenzotriazole class.

29. The method as defined in claim 20 wherein
the amount of said ultraviolet light absorber, by weight, is between about 0.55% and 3.00% of the total weight of the polymer dispersion.

30. The method as defined in claim 19 including the step of adding a light stabilizer.

31. The method as defined in claim 30 wherein
said light stabilizer a hindered amine light stabilizer.

32. The method as defined in claim 30 wherein
wherein the amount of said light stabilizer, by weight, is between about 0.55% and 2.00% of the total weight of the polymer dispersion.

33. The method as defined in claim 20 including the step of adding a fungicide.

34. A water based coating as defined in claim 33 wherein
said fungicide includes 3-iodo2-propynyl butyl carabate.

35. A water based coating as defined in claim 33 wherein
wherein the amount of said fungicide, by weight, is between about 0.3% and 1.0% of the weight of the water.

36. The method as defined in claim 20 including the step of adding a biocide.

37. The method as defined in claim 36 wherein
said biocide includes an aminoethanol compound.

38. The method as defined in claim 36 wherein
wherein the amount of said biocide, by weight, is between about 0.61% and 1.00% of the total weight of said water.

39. The method as defined in claim 20 wherein
said first pre-mix includes a fungicide.

40. The method as defined in claim adding a biocide after said first and second pre-mixes are combined.
